(19) United States
(12) Patent Application Publication
(10) Pub. No.: US 2006/0125655 A1
(43) Pub. Date: Jun. 15, 2006

(54) System and method for signaling status of traffic flow

(76) Inventor: Timothy H. McMahon, Boynton Beach, FL (US)

Correspondence Address: FISH & RICHARDSON P.C., P.O. BOX 1022, MINNEAPOLIS, MN, 55440-1022, US

(21) Appl. No.: 11/002,177

(22) Filed: Dec. 2, 2004

(51) Int. Cl. G08G 1/095

(52) U.S. Cl. 340/907

(57) ABSTRACT

In one general aspect, a method for signaling traffic flow information includes monitoring a status for a traffic restrictor, generating a wireless signal indicative of the status of the traffic restrictor, and communicating the wireless signal to a receiver. In another general aspect, a wireless receiver includes a wireless interface and a processor. The wireless interface receives a wireless signal indicative of a status of a traffic restrictor. The processor determines a portion of a route for a vehicle based upon the status of the traffic restrictor.

### TECHNICAL FIELD

This disclosure relates generally to traffic flow management, and more particularly to a system and method for signaling status of traffic flow.

### BACKGROUND

Vehicle traffic flow may be controlled or impeded by a variety of conditions. For example, traffic lights control the ability of vehicles to move through an intersection. In some cases, how a particular condition affects the traffic flow may depend on a status for the traffic condition. Thus, for example, if a traffic light is red for one direction, traffic flow in that direction is impeded in that direction for a certain period of time. Drivers often become aware of the status of a particular traffic flow device only after viewing the device, which limits the ability of drivers to be aware of traffic conditions and to adjust their routes accordingly. Particularly in the case of emergency vehicles, this can substantially interfere with the ability of vehicles to reach a destination in a timely manner. Also, in conditions of limited visibility, such as rainstorms or fog, these problems can become even more pronounced.

### SUMMARY

This disclosure relates to a system and method for signaling status of traffic flow. Various implementations of such a system or method may help to reduce or eliminate drawbacks associated with drivers being unaware of the status of traffic flow at a particular location. In one general aspect, a method for signaling traffic flow information includes monitoring a status for a traffic restrictor, generating a wireless signal indicative of the status of the traffic restrictor, and communicating the wireless signal to a receiver. In another general aspect, a wireless receiver includes a wireless interface and a processor. The wireless interface receives a wireless signal indicative of a status of a traffic restrictor. The processor determines a portion of a route for a vehicle based upon the status of the traffic restrictor.

Certain implementations may include one or more of the following features. Wireless signals may be encrypted. A central station may relay wireless signals from a signaling station to a vehicle. Traffic restrictors may include a traffic light (having a color associated with a particular direction), a weather condition, or a road hazard. Wireless receivers may be located within a vehicle. Positioning systems, such as global positioning system (GPS) locators, may be used to determine positions for traffic restrictors and/or vehicles, and may further be used to determine a vehicle's heading and speed. Methods for determining a route may include steps such as determining that a particular route requires a change in the status of a traffic restrictor and communicating a wireless request for the status change. Methods for signaling traffic flow information may further include receiving a request to change the status of the traffic restrictor and changing the status of the traffic restrictor in response to the request.

### DESCRIPTION OF DRAWINGS

FIG. 1 depicts a traffic signaling system that communicates status information for traffic control devices to vehicles;

FIG. 2 depicts a wireless receiver used in a vehicle to receive traffic flow information from a traffic signaling system; and

FIG. 3 is a flowchart illustrating a process for signaling traffic flow information and determining a route using the traffic flow information.

### DETAILED DESCRIPTION

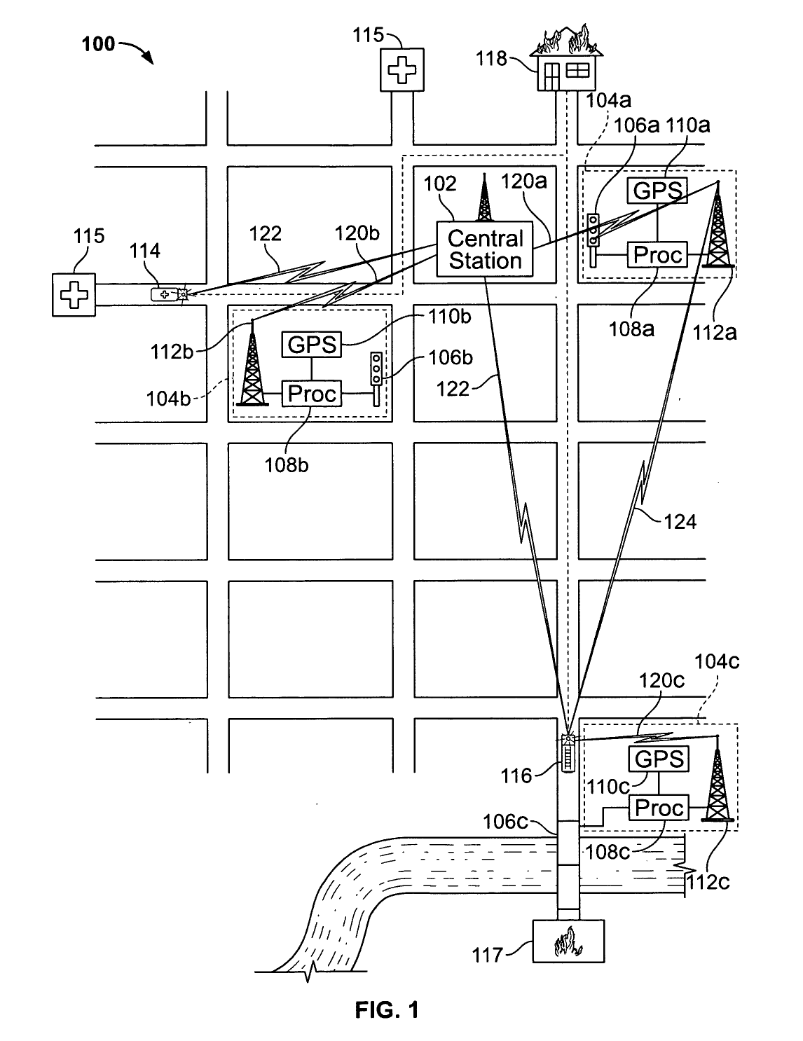

FIG. 1 illustrates an example implementation of a traffic signaling system 100. The depicted traffic signaling system 100 includes a central station 102 and various signaling stations 104 (e.g., stations 104a, 104b, and 104c). Overall, the system 100 signals the status of traffic flow to emergency vehicles, such as an ambulance 114 and a fire truck 116. The traffic status information may then be used to allow the emergency vehicles 114 and 116 to reach the location of an emergency (illustrated as a destination 118) expeditiously.

The central station 102 serves as a coordination point for receiving and broadcasting traffic status information from the signaling stations 104. The central station 102 may also receive communications (such as commands) from vehicles and relay those communications to the signaling stations 104. The central station 102 and the signaling stations 104 communicate with one another and with the emergency vehicles 114 and 116 using any suitable form of wireless communication. Such forms of communication may include radio frequency signals, infrared signals, satellite communication, or any other medium for wireless communication, and they may use any suitable protocol for wireless communication, including such techniques as code-division multiplexing, time-division multiplexing, or numerous other protocols. In particular implementations, wireless signals may be encrypted to restrict access to the system 100, so that only certain vehicles may receive signals from the system 100 and/or transmit messages to the system 100. Also, certain wireless communication connections, such as the connections between the central station 102 and the signaling stations 104, may be replaced with physical connections, such as wireline or optical connections.

The signaling stations 104 are each associated with a traffic control device 106. In the depicted implementation, the traffic control devices 106 include two traffic lights 106a and 106b and a drawbridge 106c. Each signaling station 104 also includes a processor 108, a global positioning system (GPS) locator 110, and a wireless interface 112 illustrated as an antenna. The processor 108 may include any hardware and/or software for processing information, including a microprocessor, microcontroller, application-specific integrated circuit (ASIC), digital signal processor (DSP), or numerous other information-processing components. Although the processors 108 are illustrated as single processors, it should be understood that multiple local and/or remote processors working together are contemplated as well. The GPS locator 110 may include any suitable device for determining the coordinates of the location where the respective signaling station 104 is placed based on signals provided by the network of GPS satellites. The use of a GPS locator 110 is only one example of a technique for specifying the location of the signaling stations 104, but it should be understood that other techniques for determining the location of the signaling stations may be employed as well. For example, the signaling stations 104 or the central station 102.could maintain pre-programmed location information.

Signaling stations 104 may be used in a centralized system 100 having a central station 102 that coordinates traffic flow signaling and management, or they may additionally or alternatively communicate directly with emergency vehicles 114 and/or 116. As shown in FIG. 1, the signaling stations 104a and 104b communicate wireless signals 120a and 120b to the central station 102, which then relays the information from the signaling stations in the form of wireless signals 122 to the emergency vehicles 114 and 116. On the other hand, the signaling station 104c associated with the drawbridge 106c communicates its wireless signal 120c directly to the fire truck 116. Similarly, the fire truck 116 is illustrated sending a command 124 to one of the signaling stations 104. Consequently, the described functions of the traffic signaling system 100 may be distributed in a decentralized manner or consolidated within one or more central stations 102, and any descriptions of particular implementations may be modified to accommodate those variations.

The traffic flow information may include any manner of useful information related to the control of traffic by the traffic flow devices 106. For example, the signaling station 104c may communicate information about the location of the drawbridge 106c and whether the drawbridge 106c is open or closed. The signaling stations 104a and 104b associated with the traffic lights 106a and 106b may communicate information such as the respective locations of the traffic lights 106a and 106b, the current signal status in a particular direction (red, yellow, green, turn light), the time until the next status change, the status after the next status change, or other similar information. This information may be used by the emergency vehicles 114 and 116 to make determinations about options for routes, about availability to respond to emergencies, about estimated time of arrival at the location of an emergency, and about whether to control traffic flow devices 106 to change status to facilitate the ability of the emergency vehicles 114 and 116 to reach the destination 118.

In one example of the operation of the traffic signaling system 100, an emergency response is triggered by a notification that there is an emergency at destination 118. In response to the notification, the ambulance 114 is dispatched from a hospital 114, and the fire truck 116 is dispatched from a fire station 117. The ambulance 114 and the fire truck 116 receive the wireless signals 122 from the central station 102 and from the signaling station 104c that indicate the status of traffic control devices 106. Based on the traffic flow information thus received, the emergency vehicles 114 and 116 may determine availability to respond to an emergency and to select a suitable route to the destination 118. Furthermore, commands may be sent to the traffic flow control devices 106 to control their respective status. Thus, for example, if the fire truck 116 determines that the status of the traffic light 106a will interfere with the fire truck 116 reaching the destination 118 by slowing or stopping the fire truck's progress, then the fire truck 116 may send a command 124 to the signaling station 104a instructing the signaling station 104a to change the status of the traffic light 104a. In other implementations, such requests may be managed and coordinated by the central station 102. Similarly, the ambulance 114 may detect the status change in the traffic light 106a and may take a route that has a traffic flow that is not impeded by the traffic light 106a, so as not to delay the progress of the fire truck 116 to the destination 118. The traffic signaling system 100 may also be used to determine the availability of the emergency vehicles 114 and 116. For example, if the drawbridge 106c had been open and the fire truck 116 was unable to response to the emergency in a timely manner, the information would allow a different emergency vehicle to be summoned from another location to address the emergency. The information provided by the traffic signaling system 100 may also be used on the return path, so that if, for example, traffic flow to the hospital 115 is impeded, the ambulance 114 may travel to a different hospital 115.

Although a particular implementation of the traffic signaling system 100 in an emergency response system has been described, it should be understood that the described techniques are readily adaptable to use with all other types of vehicles. For example, non-emergency vehicles may use status information from the traffic signaling system 100 to select more desirable routes based on the status of traffic control devices 106. Also, the status information for impediments to traffic flow need not be limited to traffic control devices 106. The traffic signaling system 100 may also provide information such as weather conditions (examples of which include fog on the roadway or flooded roadways), road hazards (such as wrecks), or other condition potentially adverse to traffic. In general, the traffic signaling system may be adapted to use with any traffic restrictor, where “traffic restrictor” refers to any localized device or condition that may impede traffic depending on a status of the device or condition.

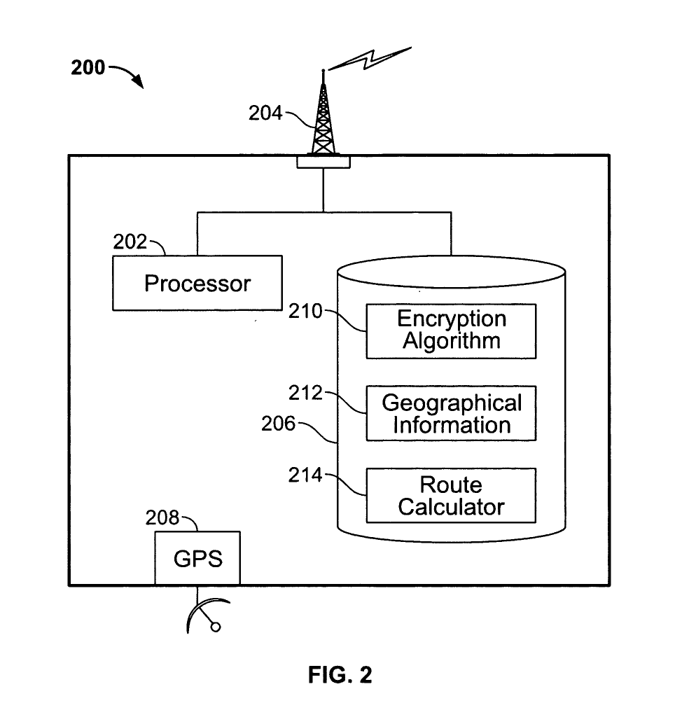

FIG. 2 illustrates an example of a wireless receiver 200 that receives information from the traffic signaling system 100 and determines a route based on that information. In the depicted embodiment, receiver 200 includes a processor 202, a wireless interface 204, a memory 206, and a positioning system 208. The memory 206 stores an encryption algorithm 210, geographical information 212, and an algorithm 214 for calculating routes (37 route calculator 214”) based on information received from the traffic signaling system 100.

The processor 202 may include any hardware and/or software for processing information, including a microprocessor, microcontroller, application-specific integrated circuit (ASIC), digital signal processor (DSP), or numerous other information-processing components. Although depicted as a single processor 202, the functions performed by the processor 202 may also be distributed among several components. The wireless interface 204 allows the wireless receiver 200 to receive information from the traffic signaling system 100 in any form and using any protocol appropriate to the traffic signaling system 100. The wireless interface 204 may also allow the wireless receiver 200 to transmit signals to the traffic signaling system 100. The memory 206 may be any form of information storage accessible by the processor 202, which may be local, remote, and/or removable. The memory 206 may include a suitable information storage medium, such as magnetic media or optical media, and it may be volatile or non-volatile. The positioning system 208 may be any suitable device for tracking the position of the wireless receiver 200, including but not limited to a GPS locator. The positioning system 208 may also measure characteristics for a vehicle carrying the wireless receiver 200, such as the vehicle's heading and speed, either by direct measurement (e.g., compass readings, speedometer values) or by calculation from position information.

The information stored in memory 206 is used by the processor 202 to perform a variety of functions. The encryption algorithm 210 encrypts and/or decrypts messages exchanged with the traffic signaling system 100. Any encryption algorithm suitable for use with the protocol of the traffic signaling system 100, with a public or private key, may be used, and the encryption algorithm 210 may also include authentication or other security measures to allow the wireless receiver 200 to obtain access to the traffic signaling system 100. The geographical information 212 may include any geographical description of the locality around the traffic signaling system 100, such as street maps, speed limits, or any other form of information useful in selecting among various routes using criteria specified by the route calculator 214. The route calculator 214 applies suitable selection and/or optimization routines to select a route using traffic flow information from the traffic signaling system 100, position information from the positioning system 208, and geographical information 212. Selection and/or optimization criteria may include such considerations as determining the shortest route, the quickest route, the route with the fewest traffic restrictors, and the like. The route calculator 214 may also take into account whether the status of traffic control devices 106 can be changed, such as, for example, by sending a wireless command signal to the traffic control device 106.

In operation, the wireless receiver 200 receives information from the traffic signaling system 100 in the form of a wireless signal. The wireless interface 204 extracts the information from the wireless signal, and the processor 202 decrypts the information using the encryption algorithm 210. Using geographical information 212 and position information from the positioning system 208, the processor 202 determines at least a portion of a route by applying the route calculator 214, suitably modifying the route based on traffic flow information. If the processor 202 determines that the status of a traffic control device 106 needs to be changed, the processor 202 sends a command to the traffic control device 106 using the wireless interface. In certain implementations, the process of calculating the route can be performed periodically or continuously based on updated traffic flow information, so that a vehicle can be rerouted in real time in response to new conditions, such as changes in the status of a traffic restrictor, decreased vehicle speed, or other factors affecting the route calculations.

Various other implementations of the wireless receiver 200 are also possible. For example, the changes of status for traffic control devices 106 may be controlled by the central station 102. In such implementations, wireless receiver 200 may communicate a request for a status change. The central station 102 may elect to change the status of the traffic control device 106 and confirm that the status has been changed in a response to the wireless device 200. Alternatively, the central station 102 may deny the request and instruct the wireless device 200 to determine an alternate route. In another example, the route calculations can be performed at a central station 102, and in such implementations, the route calculator 210 and some or all of the geographical information 208 may be maintained at the central station 102 rather than at the wireless receiver 200. It should be understood that such implementations can be used in the traffic signaling system 100 and the wireless receiver 200.

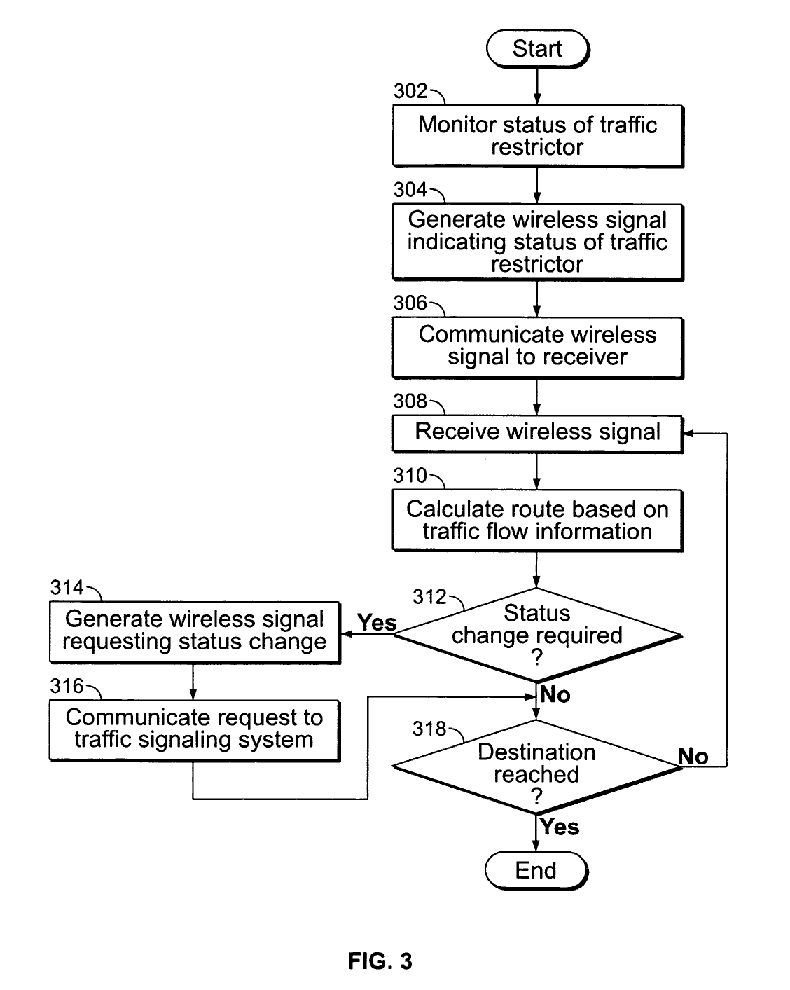

FIG. 3 is a flowchart 300 illustrating a process for signaling traffic flow information and determining a route using the traffic flow information. In particular, steps 302-306 relate to signaling traffic flow information. In certain implementations, signaling stations 104 perform these steps as part of the traffic signaling system 100. The status of their respective traffic restrictors is monitored at step 302. A wireless signal indicative of the status is generated at step 304, and the wireless signal is communicated to a receiver at step 306. In particular implementations, the receiver may be the central station 102, which relays the status information to vehicles, or the receiver may be a wireless receiver 200 associated with a vehicle. Steps 302-306 may be performed continuously and repeatedly, providing a constant source of status information on traffic restrictors.

Steps 308-318 describe a receiver receiving the wireless signal and determining a route using the traffic flow information provided in the wireless signal. In particular implementations, the receiver may be the wireless receiver 200 described above. In various implementations, the receiver may receive the wireless signal directly from the signaling station 104 and/or indirectly via the central station 102. The receiver performs the steps of the method as follows. The receiver receives the wireless signal at step 308. Using the traffic flow information received in the wireless signal, the receiver calculates at least a portion of a route at step 310 based on the traffic flow information, along with suitable geographical information 208 and/or position information about the vehicle being routed. If the calculated route involves changing the status of a traffic flow device 106, as shown by decision step 312, then the receiver generates a wireless signal requesting a status change at step 314. The receiver then communicates the signal to the traffic signaling system 100 at step 316. If no status change is required, then no such signal needs to be sent. Once the route is calculated and all appropriate requests for status change have been sent, the receiver may repeat the process from step 308 until the destination 118 is reached by the vehicle, as shown at decision step 318.

Obviously, the process described here is merely one example of numerous possible methods for signaling traffic flow information and/or determining a route based on the traffic flow information. Accordingly, many of the steps in this flowchart may take place simultaneously and/or in different orders than as shown. Moreover, processes with additional steps, fewer steps, and/or different steps, so long as the processes are consistent with any of the techniques described or suggested herein. In particular, any method of operation suitable for use with any of the implementations of the traffic signaling system 100 described above may be employed. In one example, the described method may be adapted for use in a decentralized traffic signaling system allowing vehicles to exchange information directly with signaling stations. In another example, particular functions may be performed by a central station 102, so that, for example, the route calculations may be performed at the central station 102 and communicated to the vehicles.

The described techniques can be implemented in digital electronic circuitry, integrated circuitry, or in computer hardware, firmware, software, or in combinations thereof. Apparatus for carrying out the techniques can be implemented in a software product (e.g., a computer program product) tangibly embodied in a machine-readable storage device for execution by a programmable processor; and processing operations can be performed by a programmable processor executing a program of instructions to perform the described functions by operating on input data and generating output. The techniques can be implemented advantageously in one or more software programs that are executable on a programmable system including at least one programmable processor coupled to receive data and instructions from, and to transmit data and instructions to, a data storage system, at least one input device, and at least one output device. Each software program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory, a random access memory and/or a machine-readable signal (e.g., a digital signal received through a network connection). Generally, a computer will include one or more mass storage devices for storing data files; such devices include magnetic disks, such as internal hard disks and removable disks, magneto-optical disks, and optical disks. Storage devices suitable for tangibly embodying software program instructions and data include all forms of non-volatile memory, including by way of example semiconductor memory devices, such as EPROM (electrically programmable read-only memory), EEPROM (electrically erasable programmable read-only memory), and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the techniques can be implemented on a computer system having a display device such as a monitor or LCD (liquid crystal display) screen for displaying information to the user and a keyboard and a pointing device such as a mouse or a trackball by which the user can provide input to the computer system or a system which enables input and presents information via voice, symbols, or other means such as a Braille input and output system. The computer system can be programmed to provide a graphical user interface through which computer programs interact with users. With new technologies such as voice input and output, it is not a requirement to have a visual display to implement the described techniques.

Although this disclosure has been described in terms of certain embodiments and generally associated methods, alterations and permutations of these embodiments and methods will be apparent to those skilled in the art. For example, various functions of the traffic signaling system 100 may be consolidated within the described components or additional components, such as central station 102, or such functions may be distributed differently among described components or additional components. Accordingly, the above description of example embodiments does not define or constrain this disclosure. Other changes, substitutions, and alterations are also possible without departing from the spirit and scope of this disclosure.

What is claimed is:

1. A method for signaling traffic flow information, comprising:
monitoring a status for a traffic restrictor;
generating a wireless signal indicative of the status of the traffic restrictor; and
communicating the wireless signal to a receiver.

2. The method of claim 1, further comprising:
receiving a request to change the status of the traffic restrictor; and
changing the status of the traffic restrictor in response to the request.

3. The method of claim 1, wherein:
the traffic restrictor is a traffic light; and
the status comprises a color for the traffic light associated with a particular direction.

4. The method of claim 1, wherein the traffic restrictor is selected from the group consisting of: a weather condition and a road hazard.

5. The method of claim 1, wherein the receiver comprises a wireless receiver in a vehicle.

6. The method of claim 1, wherein:
the receiver is located at a central station; and
the method further comprises relaying the wireless signal from the central station to at least one vehicle.

7. The method of claim 1, further comprising encrypting the wireless signal.

8. The method of claim 1, further comprising determining a position of the traffic restrictor using a global positioning system (GPS) locator, wherein the status of the traffic restrictor comprises the position.

9. A signaling station, comprising:
a processor operable to monitor a status for a traffic restrictor; and
a wireless interface operable to generate a wireless signal indicative of the status of the traffic restrictor and to communicate the wireless signal to a receiver.

10. The signaling station of claim 9, wherein:
the wireless interface is further operable to receive a request to change the status of the traffic restrictor; and
the processor is further operable to change the status of the traffic restrictor in response to the request.

11. The signaling station of claim 9, wherein:
the traffic restrictor is a traffic light; and
the status comprises a color for the traffic light associated with a particular direction.

12. The signaling station of claim 9, wherein the traffic restrictor is selected from the group consisting of: a weather condition and a road hazard.

13. The signaling station of claim 9, wherein the receiver comprises a wireless receiver in a vehicle.

14. The signaling station of claim 9, wherein:
the receiver is located at a central station; and
the central station is operable to relay the wireless signal from the central station to at least one vehicle.

15. The signaling station of claim 9, wherein the processor is further operable to encrypt the wireless signal.

16. The signaling station of claim 9, further comprising a global positioning system (GPS) locator operable to determine a position for the traffic restrictor, wherein the status of the traffic restrictor comprises the position.

17. An article comprising a machine-readable medium storing instructions for causing data-processing equipment to perform operations comprising:
receiving a wireless signal indicative of a status of a traffic restrictor; and
determining at least a portion of a route for a vehicle based upon the status of the traffic restrictor.

18. The article of claim 17, wherein:
the step of determining at least the portion of the route comprises determining that a change in the status of the traffic restrictor is required for the route; and
the method further comprising communicating a wireless request to change the status of the traffic restrictor.

19. The article of claim 17, wherein:
the traffic restrictor is a traffic light; and
the status comprises a color for the traffic light associated with a particular direction.

20. The article of claim 17, wherein the traffic restrictor is selected from the group consisting of: a weather condition and a road hazard.

21. The article of claim 17, wherein the instructions are further operable to cause the data-processing equipment to perform the operation of determining a speed and a heading for the vehicle, wherein at least the portion of the route is determined based on the speed and the heading of the vehicle.

22. A wireless receiver, comprising:
a wireless interface operable to receive a wireless signal indicative of a status of a traffic restrictor; and
a processor operable to determine at least a portion of a route for a vehicle based upon the status of the traffic restrictor.

23. The wireless receiver of claim 22, wherein:
the processor is further operable to determine that a change in the status of the traffic restrictor is required for the route; and
the wireless interface is further operable to communicate a wireless request to change the status of the traffic restrictor.

24. The wireless receiver of claim 22, wherein:
the traffic restrictor is a traffic light; and
the status comprises a color for the traffic light associated with a particular direction.

25. The wireless receiver of claim 22, wherein the traffic restrictor is selected from the group consisting of: a weather condition and a road hazard.

26. The wireless receiver of claim 22, further comprising a positioning system operable to determine a position for the vehicle.

27. The wireless receiver of claim 26, wherein:
the positioning system is further operable to determine a speed and a heading for the vehicle; and
the processor is further operable to determine at least the portion of the route based on the speed and the heading of the vehicle.

28. The wireless receiver of claim 26, wherein the positioning system comprises a global positioning system (GPS) locator.
